(19) United States
(12) Patent Application Publication
(10) Pub. No.: US 2005/0177553 A1
(43) Pub. Date: Aug. 11, 2005

(54) Optimized distinct count query system and method

(76) Inventors: Alexander Berger, Sammamish, WA (US); Alexander Gourkov Balikov, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/774,885

(22) Filed: Feb. 9, 2004

(51) Int. Cl. G06F 7/00

(52) U.S. Cl. 707/3

(57) ABSTRACT

The present invention relates to a system and method of optimizing execution of a distinct count query. The system and method allows clients or database administrators to improve queries by properly designing data cubes and partitions of the data in the cube. The partition data can also be ordered so as to facilitate determining the range of each partition. Partitions with overlapping ranges can be executed in parallel. Furthermore, partitions with non-overlapping ranges can also be executed in parallel to optimize query execution rather than digressing from parallel to sequential execution by virtue of their range.

### TECHNICAL FIELD

The present invention relates generally to an analytical database system and more particularly toward computation optimization of distinct count query.

### BACKGROUND

Online analytical processing (OLAP) is a technology that facilitates analysis of data through multidimensional data models. In OLAP, data is represented conceptually as a cube. Each dimension of a cube is an organized hierarchy of categories or levels. Categories typically describe a similar set of members upon which an end user wants to base an analysis. A dimension is a structural attribute of a cube which defines a category. For example, a dimension may be time which can include an organized hierarchy of levels such as year, month, and day. Additionally a dimension may be geography which can include levels such as country, state, and city. Cubes contain measures, which are sets of values based on a column in the cubes fact table. Typically, numeric measures are the central values of a cube that are analyzed. That is, measures are the data of primary interest to end users browsing or querying a cube. The measures selected depend on the types of information end users request. Some common measures are sales, cost, expenditures, and production count. For each measure in a cube, values or data can be stored in a plurality of cells.

Users can query and analyze data by, among other things, applying aggregate functions to measures. Aggregate functions can include sum, min, max, count, and distinct count. For sum, the measure value for a cube cell can be calculated by adding the values in the measure's source column from only the rows for the combination of members that defines the cell and the descendants of those members. Sum can be employed, for instance, to determine total revenue or expenses associate with one or more products. For min, the measure value for a cube cell can be calculated by taking the lowest value in the measure's source column from only the rows for the combination of members that defines the cell and the descendants of those members. In the case of max, the measure value for a cube cell can be calculated by taking the highest value in the measure's source column from only the rows for the combination of members that defines the cell and the descendants of those members. Min and Max can be used, for example, to retrieve the minimum and/or maximum sale price of a product. For count, the measure value for a cube cell can be calculated by adding the number of values in the measure's source column from only the rows for the combination of members that defines the cell and the descendants of those members. In other words count returns a numerical value associated with a particular measure or measures. For example, in a sales cube, count can return the number of customers that purchased a particular product. Distinct count measures or queries can be employed to determine for each member of a dimension how many distinct or unique measure values exist in rows of a fact table. Furthermore, sometimes measure values can represent members from other dimensions. For instance, in a sales cube distinct count can determine the number of unique customers that purchased a particular product within some time period or the number of distinct products purchased by a particular customer group. A regular count function cannot accomplish these kinds of tasks and will likely produce incorrect results, because double counts can occur. For instance, in determining the number of distinct customers that purchases a product, if a single customer buys a product more than once, then a regular count function will count the customer numerous times. To remedy this situation and count the names of customers only once, the distinct operator is employed. The distinct count operator causes duplicates to be filtered out so that the count only includes unique customers.

Databases are popular and useful because of their ability to store large amounts of data that can be easily retrieved and manipulated by specifying a query on the data. OLAP databases store large amounts of historical data for analysis. Analytic databases, such as OLAP, are often employed to store sales data or inventory data although they are not limited thereto. Calculating results over large amounts of data is computationally demanding on a system as huge amounts of data (e.g., millions of sales) need to be scanned to produce a single number result. Conventionally, systems would scan through every record in relevant databases (e.g., Sales 2000-2003) to produce several result tables that must then be merged together to produce a final result set that can be utilized to determine a correct count. This significantly impacts system performance and if the data is large enough can be computationally prohibitive. Thus, users at the very least can experience sizeable delays (e.g., hours, days) in the retrieval of data from large databases.

Accordingly, there is a need in the art for an optimized system and method for performing distinct count functionality, especially with respect to large databases.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Aspects of the subject invention relate to the optimization of a distinct count query on large quantities of data (e.g. on an OLAP database). Accordingly to one aspect of the present invention, data can be pre-aggregated to decrease execution time of a query when initiated. In particular, pre-aggregation can include, among other things, partitioning and ordering data. For instance, if the data to be queried is concerned with sales, data can be partitioned by sales year (e.g., 1999, 2000, 2001 . . . ), and if the distinct count query concerns the number of distinct customers that purchase a product over some period of time (e.g., 1999-2001) then the data in the partitions can be ordered from lowest to highest customer identification number (a/k/a customer id). Partitioning data in the manner suggested by the present invention produces highly scalable query processing system that is able to analyze huge amounts of data by spreading it across a plurality of servers or processors. Additionally, partitioning data produces a query processing system that is amendable to expeditious execution via parallel processing. Furthermore, ordering of data within each partition facilitates reducing distinct query processing time and thus response time to a distinct count query.

According to another aspect of the invention, the pre-aggregated data can be received by a query processor component and utilized to optimally execute distinct queries. More specifically, the range of each partition can be determined and used to identify independent partitions or partition groups. Independent partitions or partition groups have a range of values or measures (e.g. customer ids) that do not overlap with other partitions. One of several problems identified and solved by the subject invention is that of the digressing parallel process, where one or more partitions because of their range of values are blocked from being executed until other partitions are finished executing. This results in a parallel process digressing to a sequential process when particular partitions are queried. Once independent partitions are identified according to an aspect of the invention they can be executed concurrently with the execution of overlapping partitions thereby eliminating the digressing parallel process problem.

According to yet another aspect of the subject invention, all partitions are executed in parallel. Hence, partitions with overlapping ranges are executed in parallel while independent partitions or partition groups are executed concurrently without synchronization with the partitions containing overlapping ranges. Accordingly, complete parallel processing is supported by the present invention to optimize execution of distinct count queries.

According to still another aspect of the subject invention, one or more buffers can be utilized to examine partition data in chunks or sections. Examining data in sections rather than all at once allows the system of the present invention to be somewhat immune to partition size.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a schematic block diagram of a distinct count query system in accordance with an aspect of the subject invention.

FIG. 2 is a block diagram of an exemplary query batch to illustrate advantages associated with the present invention.

FIG. 3 is a block diagram of two exemplary query batch processes in accordance with an aspect of the subject invention.

FIG. 4 is a schematic block diagram of a parallel processing system in accordance with an aspect of the present invention.

FIG. 5 is a schematic block diagram for pre-aggregating data in accordance with an aspect of the present invention.

FIG. 6 is a flow chart diagram of a distinct count query methodology in accordance with an aspect of the subject invention.

FIG. 7 is a flow chart diagram illustrating a methodology associated with pre-aggregating data in accordance with an aspect of the subject invention.

FIG. 8 is a flow chart diagram of a distinct count query methodology in accordance with an aspect of the subject invention.

FIG. 9 is a flow chart diagram of a distinct count query methodology in accordance with an aspect of the present invention.

FIG. 10 is a schematic block diagram illustrating a suitable operating environment in accordance with an aspect of the present invention.

FIG. 11 is a schematic block diagram of a sample-computing environment with which the present invention can interact.

### DETAILED DESCRIPTION

The present invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope or spirit of the subject invention.

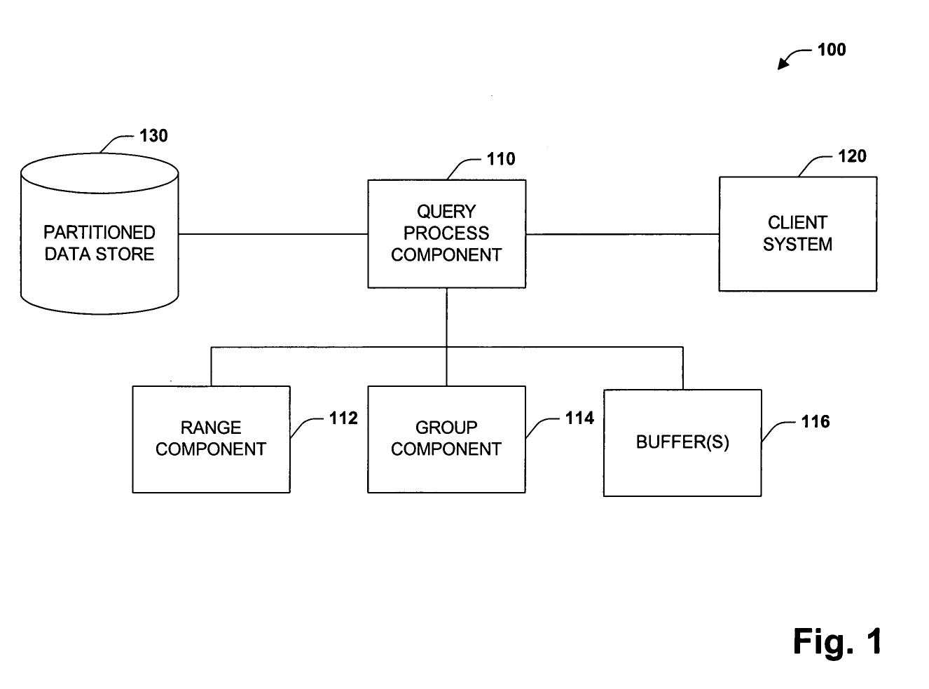

Turning to FIG. 1, a system for executing a distinct count query 100 is disclosed in accordance with an aspect of the subject invention. System 100 comprises a query process component 110, a client system 120, a partitioned data store 130, a range component 112, a group component 114, and buffer(s) 116. Query process component 110 receives a distinct count query from a client, for instance, via client system 120. Client system 120 can be any type of computer system (e.g., personal computer, workstation . . . ) as described further in sections infra. A client or user can employ client system 120 to specify a distinct count query of data stored in data store 110. For instance, a user could specify sales queries such as “What are the number of distinct customers that purchased a particular product during a specific time period?” or more generally “How many customers are buying each of my products?” or “How many distinct products were purchased in the fourth quarter?” Data store 110 is a database capable of storing large amounts of information. According to an aspect of the subject invention, the data store 110 is an OLAP database with ordered partitioned data stored therein. Accordingly, data store 110 stores pre-aggregated or pre-calculated data with respect to distinct count queries. Aggregation of data prior to receiving a query is an important factor in reducing overall query response time. Data aggregation can be implemented by a database administrator, determined heuristically and intelligently by an aggregation system, or a hybrid utilizing a wizard, for instance, to guide a database administrator through a series of steps for optimizing data aggregation and thus query response time. Data aggregation or pre-calculation can include dividing or separating data into optimal partitions and ordering the partitioned data. According to one aspect of the subject invention data can be separated into partitions in a distinct count data cube. Partitioned data typically includes numeric identifiers or keys. Ordering such data (e.g., from lowest to highest client identification number) can significantly reduce processing time associated with generating a response to a query. Client system 120 can communicate a distinct count query to the query processor component 110 over a network such as a wide area network (WAN) or a local area network (LAN). Alternatively, query processor component 110 can be part of the client system 120. Upon receipt of a distinct count query, query processor can retrieve pre-aggregated or pre-calculated data from data store 130 and begin to process such received data in accordance with the specified query.

To optimize execution of a distinct count query, query component 110 can utilize range component 112, group component 114, and buffer(s) 116. Range component 112 can determine the range or minimum and maximum values of partitions to be queried. For example, if the query concerned the distinct customers that bought a product then the range component would be concerned with the range of customer ids associated with each row or record. As mentioned supra, data can be pre-processed (e.g., partitioned) prior to execution. Furthermore, the data in partitions can be stored in order, such as from lowest id number to highest id number in each partition. Subsequently, the range component can determine the range of each partition at process time, for example, by reading the first record and last record in a partition.

Group component 112 can utilize the partition ranges to determine which partitions can be executed in parallel with other partitions. Parallel execution can drastically increase query performance by dividing up the query and executing independent groups simultaneously or concurrently with the execution of dependant parts. Concurrent processing of a query can be accomplished by employing a plurality of secondary or slave processors or servers to execute the query and report the results back to the primary or master processor or server. Group component 112 provides appropriate partition groupings to query process component 110 for execution. For example, if partition A has an id range of 1-10, partition B has an id range of 5-15, and partition C has an id range of 20-30, then partition C would be independent of both partitions A and B, which overlap. Accordingly, group a first group including partitions A and B could be executed in parallel with synchronization between the partitions and a second group comprising partition C can be executed independently and concurrently therewith. Furthermore, if partition A includes ids 2, 5, and 7, partition B includes ids 3, 5, and 6, partition C includes ids 10, 12, and 20, and partition D comprises ids 10, 11, 14, and 15 then although a sole independent partition cannot be found as in the previous example an independent group can be found. In this example, partitions C and D (10, 12, 20 and 10, 11, 14, 15) are independent of partitions A and B (2, 5, 7 and 3, 5, 6). Accordingly a first group comprising partitions A and B can be executed together but independent from a second group comprising partitions C and D. Thus, execution of the distinct count query can be very fast when an independent partition is found, however it is also quite expeditious when independent partition groups are found and executed separately. Additionally, it should be noted with respect to system 100 of FIG. 1 that query buffer(s) 116 can also be employed to further facilitate quick and efficient execution. Buffer(s) 116 can act as a temporary storage of chunks of data (e.g., sections of partitions) for rapid processing and/or manipulation by the query process component 110.

Furthermore, it should be noted and appreciated that OLAP database systems can have several types of partitions, such as MOLAP, HOLAP and ROLAP. MOLAP (Multidimensional Online Analytical Processing) is a partition where both the partition data and the aggregated data for this partition are stored in an OLAP database. ROLAP (Relational Online Analytical Processing) is quite the opposite. The data and the possible aggregations (if such exist) are kept in the relational database. Thus, the OLAP system can simply present a virtual view of this relational data, so to end users it appears as a normal partition. With HOLAP (Hybrid Online Analytical Processing), partitions are hybrid between MOLAP and ROLAP. For HOLAP partitions, the partition data can still be kept in the relational database, but the pre-computed aggregated data can be stored in the OLAP system. For MOLAP partitions pre-processing does not necessarily have to be performed, because when the partition is created it is pretty much ready for querying. Thus, the system of the present invention does not really need to scan the records. Therefore, the range of distinct ids (min & max) can simply be retrieved. However, for ROLAP and HOLAP partitions, such processing can be performed at that time the min-max range of ids for each partition is determined.

Therefore, the grouping component 112 may not have information for the range of ROLAP partitions at query time (however an optimized aspect of the present invention can submit queries to pre-determine these ranges.). So at query time the grouping component 112 can create the groups using only the MOLAP and HOLAP partitions for which it has range data available. Then, if there are any ROLAP partitions to be queried, the group component 112 can add each partition to groups. For each group the ROLAP partitions into such group can be queried for the range of ids determined by the containing group. Essentially, each ROLAP partition can be virtually partitioned into smaller non-overlapping sub-partitions. Subsequently, each such sub-partition can be added to a corresponding group.

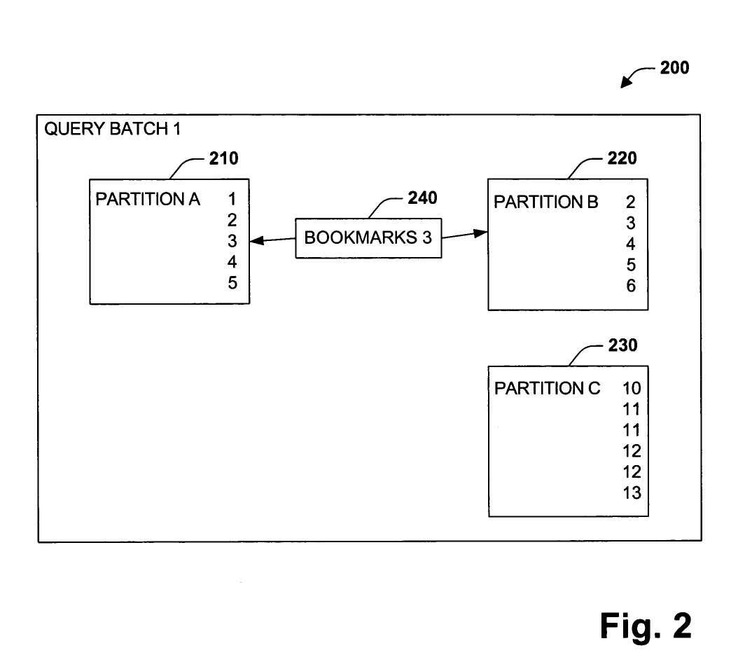

Turning to FIG. 2, an exemplary query batch 200 is depicted to illustrate an aspect of the subject invention. To facilitate expeditious execution of a distinct count query each of the three partitions, partition A 210, partition B 220, and partition C 230 are to execute in parallel within a query batch 200. To count the distinct number of customer ids, for example, one or more bookmarks 240 can be employed to keep track of the present position in each partition as the ids are scanned. According to an aspect of the invention, calculation of a distinct count entails scanning each record in every partition and counting the distinct number of customer ids in order. Accordingly, scanning of partitions would begin with partition A 210 and id no. 1. Subsequently, id no. 2 would be scanned from both partition A 210 and partition B 220. Then id no 3 would be scanned from both partitions A 210 and B 220, and so forth. As can be gleaned from this example, partition C would not be scanned until the synchronized parallel processing of both partitions A and B has been completed. Thus, all partitions are not in fact being efficiently executed in parallel as desired. If partitions happen not to contain overlapping values for the distinct count measure, they will essentially be blocked until the bookmark reaches the range of the partition. Hence, in some cases, if none of the partitions contain overlapping values the query will digress from parallel to sequential execution. Furthermore, a system that executes the distinct count query would probably allocate memory to execute partition C in parallel, however in some cases the partition will simply passively consume memory without any operations being performed thereon.

The digression from parallel to sequential execution is a result of the chosen method of querying partitions, namely storing partition data in sorted order by a distinct count measure (e.g., designated at cube creation time, so an OLAP system will know to sort the partition records by the count measure). Hypothetically there may be different implementations where the data is not sorted and there is no need to predetermine which are the distinct count measures. These implementations will most likely require huge hash tables of ids and counts, so when each record is retrieved, the system will be able to determine which count to increment. However, storing data in sorted order and scanning partitions in parallel is advantageous in that the data is essentially quickly streamed through the system and no extensive memory allocation is required.

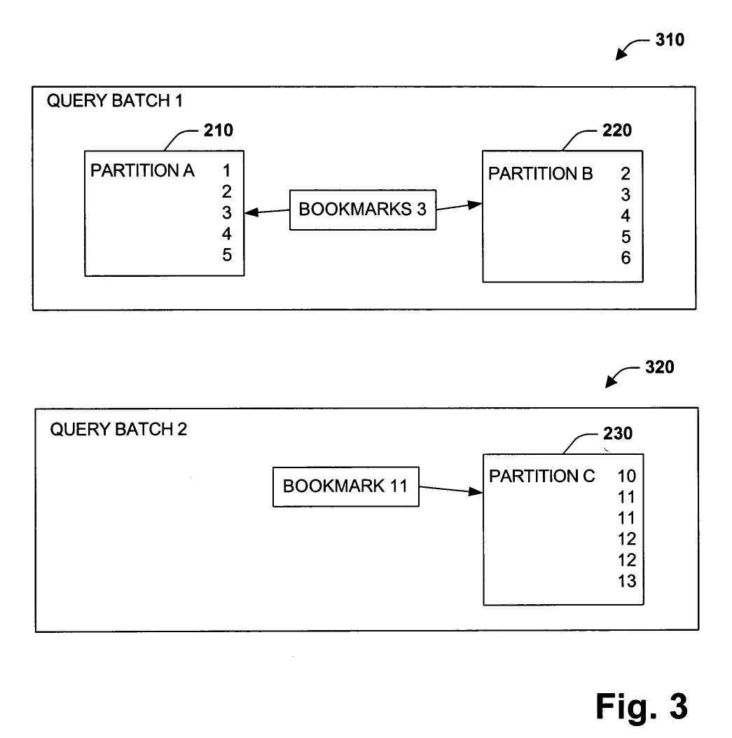

Turning to FIG. 3 exemplary batch queries 310 and 320 are illustrated in accordance with an aspect of the subject invention. As shown with respect to FIG. 2, partition processing can digress from parallel to sequential processing when partitions happen not to contain overlapping ranges. To solve this problem as well as increase the overall execution speed of a distinct count query, the present invention executes non-overlapping partitions concurrently with the processing of all other partitions. Accordingly, the subject invention, via a range component 112 (FIG. 1), can determine the ranges associated with each partition prior to beginning to process them. The group component 114 (FIG. 1) can subsequently determine from the ranges which partitions are independent, or do not overlap with other partitions, such that these partitions can be executed in parallel or concurrently with the execution of all other partitions. The range of partition A 220 is from 1 to 5, partition B's range is from 2 to 6 and partition C's range is from 10 to 13. Hence, partition A 210 and B 220 have overlapping ranges while partition C 230 does not overlap with either partition A 210 or partition B 220. According to an aspect of the invention, partitions A 210 and B 220 can be executed in their own query batch 310 and partition C 230 can be executed in a separate query batch 320 concurrently with query batch 310. This not only eliminates the blocking effect that would have resulted had the partitions been executed in a single batch as in FIG. 2, but also allows a distinct count query to be executed much faster.

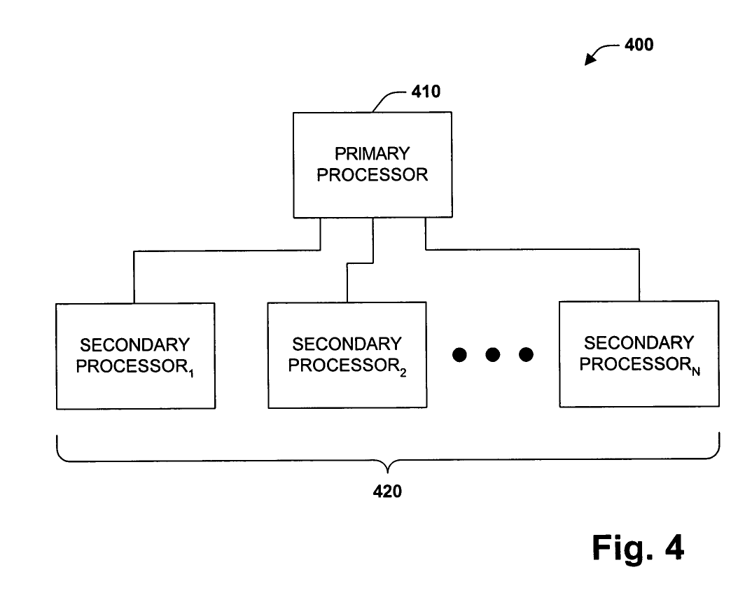

FIG. 4 illustrates a system 400 for parallel processing of partitions in accordance with an aspect of the subject invention. System 400 includes a primary processor 410 and one or more secondary processors 420 (SECONDARY PROCESSOR₁, SECONDARY PROCESSOR₂ through SECONDARY PROCESSOR_{N}, where N is an integer greater than or equal to one). Primary processor 410 is the top or highest level processor which can be responsible for grouping partitions and distribution of partitions to secondary processors 420. Primary processor 410 can also execute distinct count queries on one or more partitions. Secondary processors 420 receive one or more partitions from primary processor 410. The secondary processors 420 thereafter execute distinct count queries on partitions concurrently with the primary processor and other secondary processors. According to one aspect of the subject invention the partitions received and processed by secondary processors 420 have ranges that are independent or non-overlapping with respect to partitions processed by the primary processor 410 or other secondary processors 420. Hence, the secondary processors 420 can independently generate a distinct count value indicative of the number of distinct or unique records queried and pass that number to the primary processor 410. The primary processor can then receive distinct count values from each secondary processor and aggregate them to produce a final distinct count value that presented in response to the query. It should be appreciated that primary and secondary processors can refer to central processing units (CPUs) in any one or a plurality of arrangements or architectures including by not limited to symmetric multiprocessing systems, massive parallel processing systems (MPP), and clustered systems. Furthermore, it should be noted that partitions with overlapping ranges are also executed in parallel according to an aspect of the invention and therefore can utilize a plurality or processors in one of several arrangements or architectures.

Referring back briefly to FIG. 1, it should be noted that the query processing system 100 of the present invention comprises buffer(s) 116. It should be appreciated that the buffer(s) 116 can be utilized to further expedite processing of queries on large sets of data. Buffer(s) 116 facilitate analyzing data in manageable chunks or sections. Therefore, if a partition contains 10,000 records, for instance, a buffer can be utilized to store a section of those records (e.g., 100) for analysis. The actual number of records depends on the size of the buffer (e.g., 100 MB, 150 MB . . . ) and the size of the records. After all the records in the buffer have been analyzed, subsequent records can be scanned into the buffer for analysis cyclically until such time that all records have been analyzed. Utilizing buffer(s) 116 to look at sections of a partition not only speeds up query execution time, but also enables the system to be scalable and handle extremely large partitions. Without utilizing manageable sections it would be extremely difficult if not impossible to execute distinct count queries on very large partitions.

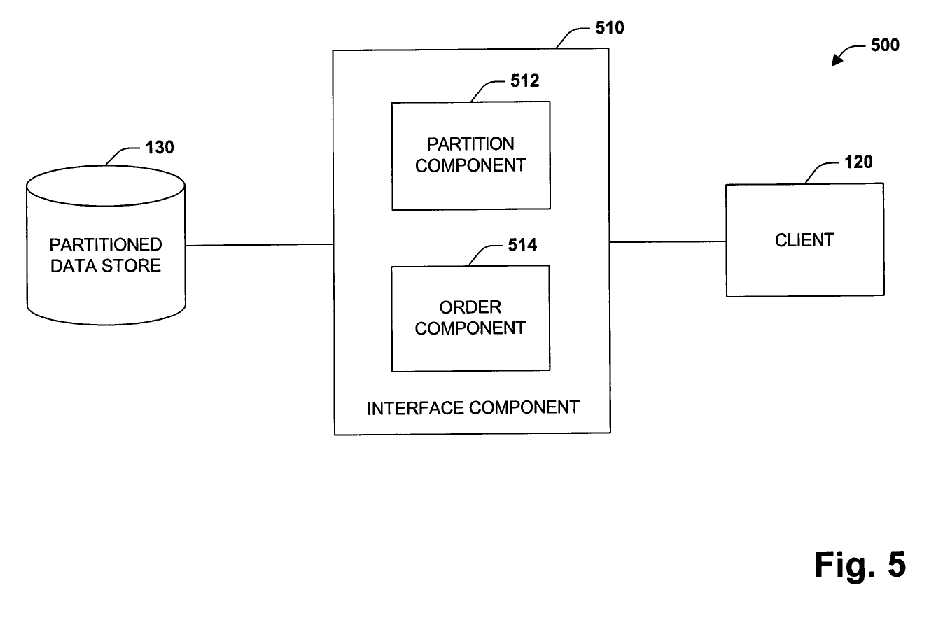

FIG. 5 depicts a system 500 for pre-aggregating data is illustrated in accordance with an aspect of the subject invention. To facilitate optimized execution, distinct count measures can be pre-aggregated into partitions and stored in their own data cube, for instance. System 500 includes a client or client system 120, an interface component 510 and a data store 130. A client or client system 120 can utilize interface component 510 to interact with data stored on the data store 130. In particular, partition component 512 of interface component 410 can be utilized by an individual or entity to partition data. Thus, partition component 512 provides a mechanism for a database administrator, for instance, to set up partitions in accordance with the particular data to be analyzed and the typical queries that are made on that data. For example, if the data is sales data (e.g., sales cube) for a company, it is known that users like to query the data to determine such things as the number of distinct customers purchasing their product during a given period. Typically, the period of interest for sales data is one or more years. Accordingly, a database administrator can generate partitions corresponding to sales years such as 1999, 2000, 2002, 2003. The measures stored therein can include customer id numbers so as to enable a distinct customer count. Utilizing numeric identifiers or keys, for instance, for products or customers further optimizes the distinct count execution time. In addition, order component 514 can be utilized by a database administrator to order the numeric identifiers, for example, from lowest to highest number, to improve processing time. Aggregation of data prior to receiving a query is an important factor in reducing overall query response time. Data aggregation can be implemented by a database administrator, determined heuristically and intelligently (e.g., utilizing neural networks, Bayesian networks . . . ) by an aggregation system or a hybrid utilizing a wizard, for instance, to guide an administrator through a series of steps for optimizing data aggregation and thus query response time.

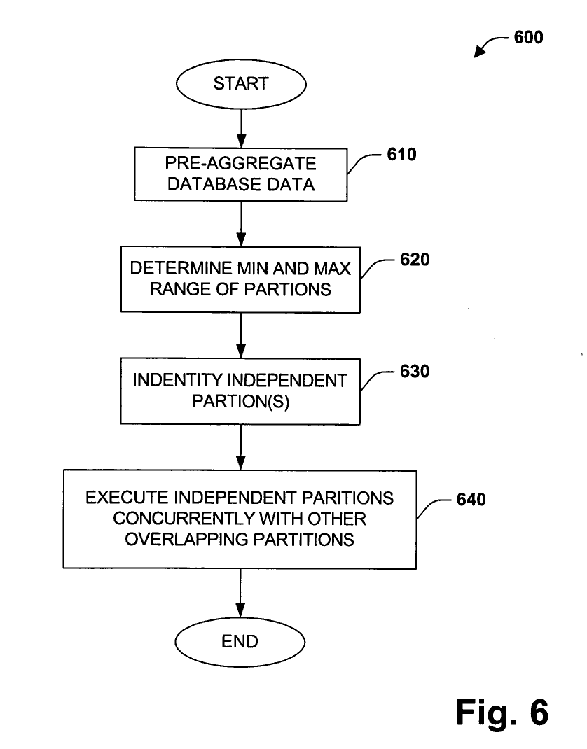

In view of the exemplary system(s) described supra, a methodology that may be implemented in accordance with the present invention will be better appreciated with reference to the flow charts of FIGS. 6-8. While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

FIG. 6 is a flow chart diagram of a distinct count query methodology in accordance with an aspect of the subject invention. At 610 database data is pre-aggregated to expedite real time query processing. Examples of pre-aggregations include partitioning a database, ordering database elements or values, and eliminating duplicative entries in partitions. At 620, the minimum and maximum range of each partition is determined. This can be accomplished by simply retrieving the first and last entries in each ordered partition. Subsequently, independent partitions can be identified at 630. Independent partitions correspond to partitions whose range of entries does not overlap with the range of other partitions. Accordingly, independent partitions can be easily identified by comparing the ranges of each partition. For example, if partition A has a range of 1-10, partition B has a range of 5-15, and partition C has a range of 20-30, then partition C would be independent of both partitions A and B, which overlap. At 640, independent partitions are executed concurrently with overlapping partitions. For example, independent partitions can be executed by a separate processor on a separate server. Such concurrent execution of independent partitions insures parallel execution of all partitions at least in that independent partitions would not be blocked from executing by other partitions. Furthermore it should be noted that partitions, both independent and overlapping, can be executed in chunks or sections in conjunction with on or more buffers to facilitated efficient analysis of large partitions.

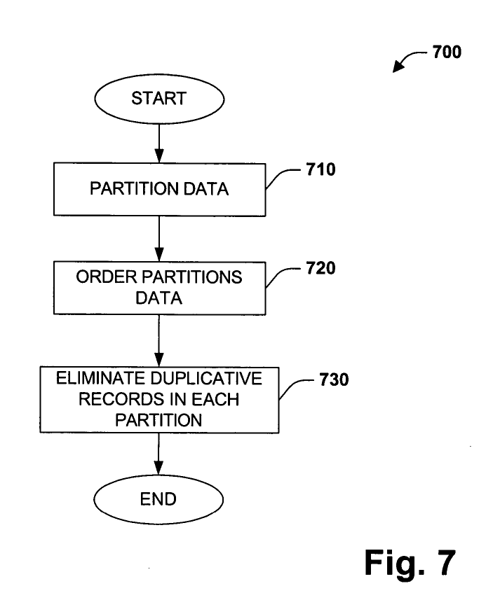

FIG. 7 is a flow chart diagram illustrating a method 700 of pre-aggregating data. At 710 data is partitioned. Database size has been increasing steadily over the years since its acceptance. Today databases can store several terabytes or more of information. Partitions, inter alia, allow large amounts of data to be scanned and manipulated by allowing data to be distributed amongst a plurality of servers or processors. Accordingly, systems that partition data are highly scalable, as they need only add more processors or servers to handle additional quantities of data. A database can be separated into partitions by a database administrator who is familiar with the data set and the most popular queries. Additionally or alternatively, heuristic tools can be utilized to assist a database administrator or to automatically and intelligently partition data. For example, if a database houses a business' sales results since the opening of the business data can be partitioned by year (e.g., 1999, 2000, 2001 . . . ), by fiscal year, by month or any other unit of time that is often a topic of inquiry. At 720, the partitions can be ordered. For example, numeric keys or identifiers associated with customers or products can be ordered from highest to lowest in the partitions. At 730, duplicate partition identifiers can be deleted from amongst a plurality of partitions. This helps expedite execution of a distinct query count by allowing an algorithmic method to focus solely on the distinction between values across partitions. Additionally, it should be noted that both partitioning of data and ordering of data associated with partitions are preprocessing steps that can be done prior to receiving a query from a user to facilitate expeditious query execution.

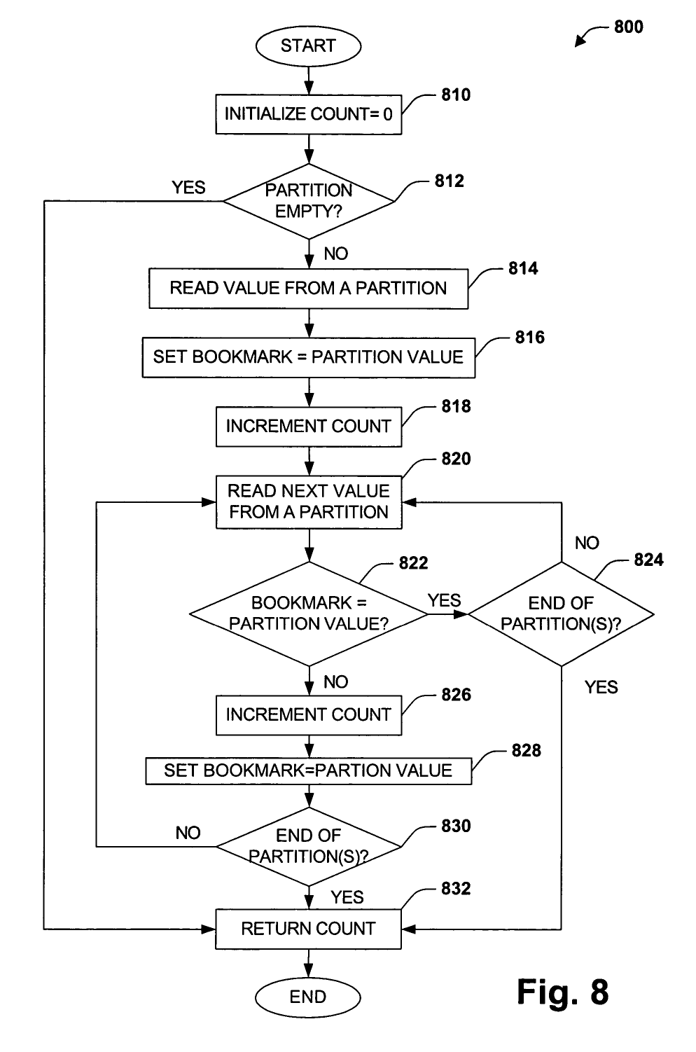

Turning to FIG. 8, an exemplary distinct query count methodology 800 is illustrated in accordance with an aspect of the subject invention. Distinct count methodology 800 describes a method of determining the number of distinct or unique records in a single partition. Such methodology can be adapted to execution of a distinct count query over a plurality of partitions in parallel as described hereinafter. At 810, a count is initialized to zero. The count variable can be utilized to keep track of the number of distinct measures in the partition. At 812, the partition is examined to determine if it contains values or it is empty. If the partition is empty the process proceeds to 832, wherein the count is returned. Since no records or measures are available to be examined if the partition is empty the value returned is zero. If, however, the partition is not empty, the first value of the partition is read at 814. Subsequently a bookmark is set to have the value of the first value read at 816. The bookmark can be employed to keep track of the values that have been examined and in general where the process is in its examination of the partition. At 818, the count is incremented. The count is incremented so as to reflect the fact that a value has been read in and copied to the bookmark. Furthermore, since no other values have been read in yet the first value is unique or distinct. Next, another value is read from the partition at 820. Assuming that the partition contains more than one value, this new value is then compared with the bookmark at 822. The comparison between the bookmark and the newly read value seeks to determine whether the value is another unique value or the same value as in the bookmark. Because the data in a partition is ordered according to an aspect of the subject invention prior to execution of the distinct count query, if there are multiple instances of a value they will appear in sequence. Thus, if the newly read value is equal to the value stored in the bookmark then the value is a duplicate and should not be counted. The process can then proceed to 824 where a determination is made as to whether the end of the partition has been reached. If there are no more values to analyze because the end of the partition has been reached then the count is returned at 832. Thus far only one value has been uniquely read so the return count would be one. If the end has not been reached, then the process proceeds to 820 where another value is read from the partition. If, however, at 822 the bookmark did not equal the newly read value then the count can be incremented at 826 to indicate the presence of another unique value. Subsequently, the bookmark will be updated to hold the value of the newly read value at 828. Next, a check is made to determine whether the end of the partition has been reached. If yes, then the count value is returned at 832. Returning the count value at 832 can refer to, inter alia, notifying a primary processor of the distinct count of the partition, for example, if the partition is an independent partition executed concurrently or simultaneously with other partitions. Alternatively, returning the count can refer to providing a client with the distinct count value is only a single partition is being queried. If the end of the partition is determined not to have been reached then the next value is retrieved at 820. The loop continues until the all values have been scanned by the method. As can be gleaned from the above description, methodology 800 is a very efficient manner of calculating distinct count. Such efficiency results in part from the fact that the data is preordered so that duplicative values follow in sequence. However, it should be appreciated that the disclosed method is exemplary and that those of skill in the art may recognized upon reading this specification various different methodologies or algorithms that are also to be considered within the scope of the present invention.

As has been mentioned throughout this detail description, parallel processing of data partitions results in a very efficient and expeditious execution of a distinct count query. In FIG. 8, a methodology 800 was disclosed for querying a single partition. Scanning or querying a single partition will most often occur when a partition is independent or in other words where a partition's range of values does not overlap with one or more other partitions. However, it is often the case that partitions do overlap. Thus, overlapping partitions should also be executed in parallel with each other. The methodology for executing overlapping partitions can be similar to that of methodology 800 regarding a single partition. In essence, a distinct count query can examine the values or measures of each partition in numeric order. Thus, if one partition contained the identifying numbers 2, 3, 4, and 5 while another partition contained the identifying numbers 4, 5, 6, 7, the distinct count query of the present invention could examine the values in the following order: 2, 3, 4, 4, 5, 5, 6 and 7.

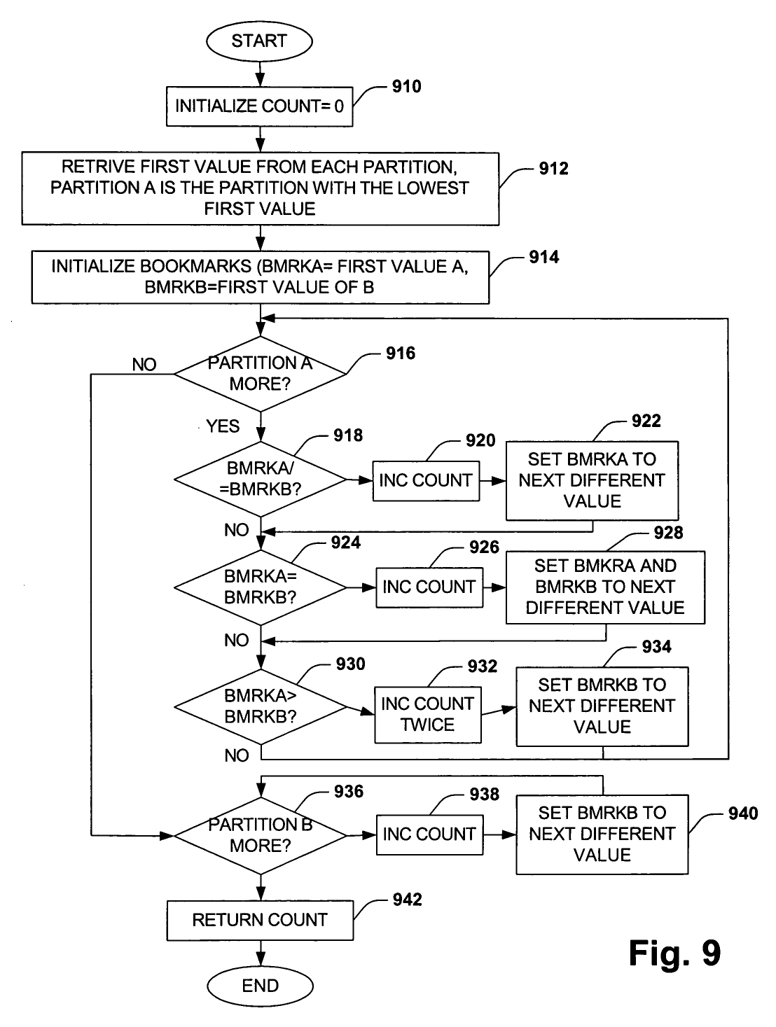

Turning to FIG. 9, an exemplary distinct count query methodology 900 is illustrated in accordance with yet another aspect of the present invention. The exemplary methodology illustrates one manner in which partitions can be examined in parallel. It should be appreciated that for purposes of clarity and understanding the methodology is only concerned with two partitions, however such methodology could be extended to deal with many more than just two partitions. Furthermore, to further simplify the methodology it is assumed that at each partition has at least one value. At 910, the distinct count is initialized to zero to indicate that no distinct values have yet been detected. At 912, the first values from each of two partitions are retrieved. The partition with the lowest first value will be the first partition to execute, accordingly it will be referred to as partition A while the other partition is partition B. At 914, bookmarks are instantiated and initialized with the values retrieved from respective partitions. Thus, BKMRK A corresponds to partition A and BKMRK B corresponds to partition B. Subsequently, at 916, partition A is examined to determine if there are any more values to be read that have not already be read an analyzed. If there are no more values to read from A then the process goes to 936 to determine if there are any more values to be examined from partition B. If, however, there are more values in partition A then the process proceeds to 918, 924, and 930 where BMRK A is compared to BMRK B. At 918, is BMRK A is not equal to BMRK B then the count is incremented once to indicate the existence of a single distinct value at 920. Then, at 922, BMRK A is set to the next different value in partition A, for instance by reading values and comparing them to the bookmark until the value is different. At 924, if BMRK A is equal to BMRK B then the count is incremented at 926 and the value BMRK A is replaced with the next different value, if available, of partition A and the value of BMRK B is replace with the next different value in partition B, if available. If, at 930, BMRK A is greater than BMRK B then the counter is incremented twice at 932 to account of the unique value in partition A and the unique value in partition B. Subsequently, the value of BMRK B is replaced with the value of the next different value in partition B, if available. Then if the bookmark values fall all the way though 930 the process proceed to 916 to determine if all the values in partition A have been accounted for and evaluated. If no, then the process loops again through 918, 924, and 930. If yes, the process goes to 936 where it is determined whether all the values in partition B have been accounted for and evaluated. If yes, then the count is returned at 942. If no, then the count is incremented, at 938, and BMRK B is assigned to the next different value in partition B, at 940. The loop will then continue until all values in partition B have been evaluated. Subsequently, the count will be returned at 942. It should be noted and appreciated returning the value at 942 might not be the final distinct count as a count from one or more independent partitions running concurrently therewith might have to be added to the count.

It should be appreciated that for the purpose of clarity the subject invention has been described in relation to a sales data or a sales cube. However, the subject invention is not limited to sales analysis. The distinct count system and method of the invention can be employed in the context of a myriad of different types of data. For example, the present invention could be employed with internet site data such that distinct queries can be executed to determine many distinct pages on the Internet site were visited by a particular user.

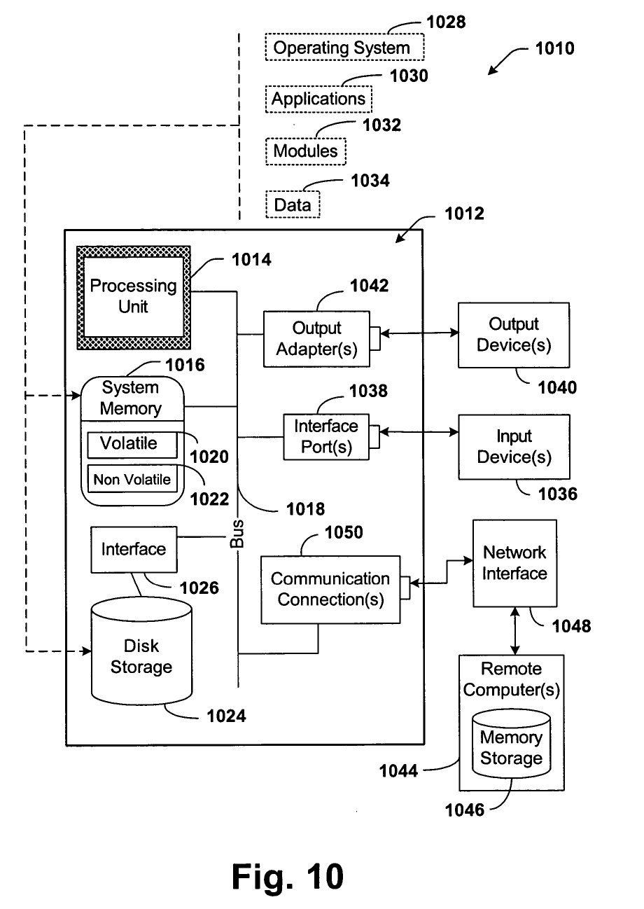

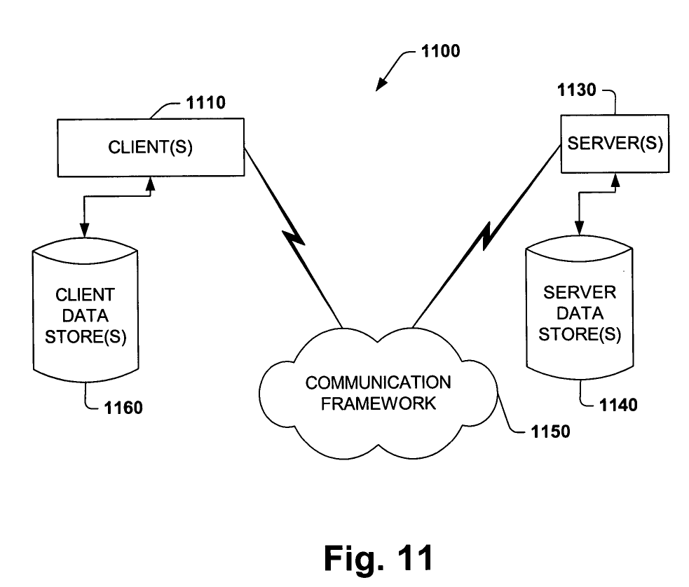

In order to provide a context for the various aspects of the invention, FIGS. 10 and 11 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example disk storage 1024. Disk storage 4124 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A distinct count query system comprising:
a query process component to retrieve a plurality of partitions from a database;
a range component that determines the maximum and minimum values associated with each partition; and
a group component that utilizes the maximum and minimum range values to determine independent partitions or partition groups, wherein independent partitions or partition groups are executed concurrently with other partitions.

2. The system of claim 1, wherein the database is an OLAP database.

3. The system of claim 1, further comprising a buffer component to facilitate execution of the distinct count query on sections of the partitions.

4. The system of claim 1, wherein the partitions contain one or more numeric identifiers.

5. The system of claim 4, wherein the numeric identifiers are ordered in ascending order from smallest to largest value.

6. The system of claim 5, wherein the numeric identifier is a customer ID.

7. The system of claim 5, wherein the numeric identifier is a product ID.

8. The system of claim 1, wherein partitions with overlapping ranges are executed in parallel.

9. A distinct query system comprising:
a means for receiving partitions from a database;
a means for identifying independent partition groups;
a means for executing independent partitions in parallel with other partitions.

10. The system of claim 9, wherein identifying independent partition groups comprises a means for determining a range of partition data.

11. The system of claim 10, wherein the independent partition groups have a non-overlapping range with respect to other partitions.

12. The system of claim 9, wherein partitions in the partition group contain ordered numeric identifiers.

13. The system of claim 9, the database is a multidimensional database.

14. A method for executing a distinct count query comprising:
determining ranges associated with partition data;
identifying independent partitions based on the partition ranges; and
executing a distinct count query on a partition group concurrently with other partitions to be queried.

15. The method of claim 14, wherein partition data includes numeric identifiers.

16. The method of claim 15, wherein the numeric identifiers are ordered in partitions.

17. The method of claim 16, wherein the identifiers are ordered in ascending order.

18. The method of claim 17, wherein the ranges are determined by retrieving the first and last values from each partition.

19. The method of claim 18, wherein an independent partition group includes one or more partitions that have non-overlapping ranges with respect to other partitions or partition groups to be queried.

20. The method of claim 19, wherein partitions with overlapping ranges are executed in parallel.

21. A computer readable medium having stored thereon computer executable instructions for carrying out the method of claim 14.

22. A method for executing a distinct count query on a database comprising:
pre-aggregating database data;
determining a minimum and maximum range of a plurality of data partitions;
identifying independent partition groups to be executed simultaneously with other queried partitions, the independent partition groups including one or more partitions with a non-overlapping range with respect to other queried partitions.

23. The method of claim 22, wherein pre-aggregating database data comprises separating data into partitions.

24. The method of claim 23, wherein data is separated automatically based on heuristics associated with the database.

25. The method of claim 23, wherein pre-aggregating database data comprises ordering partition data.

27. The method of claim 22, wherein pre-aggregating database data comprises eliminating redundant data in each partition.

28. The method of claim 22, wherein the other queried partitions include overlapping ranges which are executed synchronously and in parallel.

29. The method of claim 22, further comprising executing the distinct count query on sections of partitions utilizing a buffer.

30. The method of claim 22, the database is an OLAP database.

31. A computer readable medium having stored thereon computer executable instructions for carrying out the method of claim 22.
